(19) United States
(12) Patent Application Publication
(10) Pub. No.: US 2004/0128615 A1
(43) Pub. Date: Jul. 1, 2004

(54) Indexing and querying semi-structured documents

(75) Inventors: David Carmel, Haifa (IL); Naama Kraus, Haifa (IL); Benjamin Mandler, Zichron Yaakov (IL)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/331,454

(22) Filed: Dec. 27, 2002

(51) Int. Cl. G06F 15/00

(52) U.S. Cl. 715/513; 715/514

(57) ABSTRACT

A method for indexing a semi-structured document, the method including arranging at least one structure entity of a semi-structured document into at least one node of a context structure tree, associating a unique context identifier with any of the structure entities, creating, for any value of any of the structure entities, a context-modified value by appending a context delimiter and the context identifier to the value, and inserting the context-modified value into a free-text tree.

### FIELD OF THE INVENTION

The present invention relates to semi-structured documents in general, and more particularly to indexing and querying thereof.

### BACKGROUND OF THE INVENTION

Although there are many types of documents that can be stored on computers and computer-based networks, one method of classification designates documents as being structured, unstructured, or semi-structured. Structured documents include database files whose data are defined by a data structure, or schema, that is separate from and independent of the data, while unstructured documents include free-form text documents. Semi-structured documents, such as XML documents, can include both structured data and text.

Techniques for indexing and querying structured and unstructured documents are well known. Database indices are ubiquitous, as are inverted indices or “tries” for unstructured text documents. Unfortunately, neither are, by themselves, adequate for use with semi-structured documents. While semi-structured documents can be indexed as free-text documents, in doing so valuable context information would be lost along with the ability to support context-sensitive queries. Thus, for example, a free-text index of a semi-structured document would support a search for all occurrences of the word “red,” but not for all documents in which the word “red” appears as the color of a ball. Similarly, database indices are generally too rigid to handle the flexible structure of semi-structured documents, and would support a search for all documents in which the word “red” appears as the color of a ball, but not for all documents in which the word “red” appears. Thus, a new approach to indexing and querying semi-structured documents that supports both free-text and context-sensitive queries would be advantageous.

### SUMMARY OF THE INVENTION

The present invention provides for indexing and querying semi-structured documents in support of both free-text and context-sensitive queries.

In one aspect of the present invention a method for indexing a semi-structured document is provided, the method including arranging at least one structure entity of a semi-structured document into at least one node of a context structure tree, associating a unique context identifier with any of the structure entities, creating, for any value of any of the structure entities, a context-modified value by appending a context delimiter and the context identifier to the value, and inserting the context-modified value into a free-text tree.

In another aspect of the present invention the method further includes parsing the semi-structured document to identify any of the structure entities therein.

In another aspect of the present invention the associating step includes associating a unique context identifier with any of the structure entities.

In another aspect of the present invention the inserting step includes inserting either of the context delimiter and the context identifier as nodes in the free-text tree.

In another aspect of the present invention the method further includes associating at least one link to the semi-structured document with any of the nodes in the free-text tree.

In another aspect of the present invention the method further includes storing a data type of at least one of the structure entities in association with its corresponding node.

In another aspect of the present invention a method for querying semi-structured document indices is provided, the method including traversing, in a context structure index, one or more context nodes corresponding to a context path of a query until a context node corresponding to a terminus of the context path is reached, retrieving a context identifier of the context node, appending a context delimiter followed by the context identifier to a value of the query, thereby forming a context-modified value, traversing, in a free-text index, one or more text nodes corresponding to the context-modified value until the traversed text nodes form the context-modified value, and retrieving any links associated with any of the text nodes corresponding to either of the context delimiter and the context identifier node, thereby forming results of the query.

In another aspect of the present invention the method further includes retrieving a data type of the context node, and where the retrieving links step includes retrieving where the value satisfies a data type operation specified in the query

In another aspect of the present invention a method is provided for querying semi-structured document indices, the method including appending a context delimiter followed to a value of a query, thereby forming a context-modified value, traversing, in a free-text index, one or more text nodes corresponding to the context-modified value until the traversed text nodes form the context-modified value, and retrieving any links associated with any of the text nodes corresponding to the context delimiter, thereby forming results of the query.

In another aspect of the present invention the retrieving step additionally includes retrieving any links associated with any text nodes descending from the text node corresponding to the context delimiter, thereby forming results of the query.

In another aspect of the present invention a method is provided for querying semi-structured document indices, the method including traversing, in a context structure index, one or more context nodes corresponding to a context path of a query until a context node corresponding to a terminus of the context path is reached, retrieving a context identifier of the context node, traversing, in a free-text index, one or more text nodes corresponding to a value of the query, where the value is of a context-specific wildcard query construct, until the traversed text nodes form the value, and retrieving any links associated with any text nodes of the free-text index that descend from the terminus of the traversed value and that are at the desired context identifier, thereby forming results of the query.

In another aspect of the present invention apparatus is provided for indexing a semi-structured document, including a context structure tree including at least one node corresponding to at least one structure entity of a semi-structured document and a unique context identifier associated with the structure entity, a context-modified value including a value of the structure entity, a context delimiter, and the context identifier, and a free-text tree into which the context-modified value is inserted.

In another aspect of the present invention a system is provided for indexing a semi-structured document, the system including means for arranging at least one structure entity of a semi-structured document into at least one node of a context structure tree, means for associating a unique context identifier with any of the structure entities, means for creating a context-modified value for any value of any of the structure entities by appending a context delimiter and the context identifier to the value, and means for inserting the context-modified value into a free-text tree.

In another aspect of the present invention a system is provided according to claim 13 and the system further includes means for parsing the semi-structured document to identify any of the structure entities therein.

In another aspect of the present invention the means for associating is operative to associate a unique context identifier with any of the structure entities.

In another aspect of the present invention the means for inserting is operative to insert either of the context delimiter and the context identifier as nodes in the free-text tree.

In another aspect of the present invention the system further includes means for associating at least one link to the semi-structured document with any of the nodes in the free-text tree.

In another aspect of the present invention the system further includes means for storing a data type of at least one of the structure entities in association with its corresponding node.

In another aspect of the present invention a system is provided for querying semi-structured document indices, the system including means for traversing, in a context structure index, one or more context nodes corresponding to a context path of a query until a context node corresponding to a terminus of the context path is reached, means for retrieving a context identifier of the context node, means for appending a context delimiter followed by the context identifier to a value of the query, thereby forming a context-modified value, means for traversing, in a free-text index, one or more text nodes corresponding to the context-modified value until the traversed text nodes form the context-modified value, and means for retrieving any links associated with any of the text nodes corresponding to either of the context delimiter and the context identifier node, thereby forming results of the query.

In another aspect of the present invention the system further includes means for retrieving a data type of the context node, and where the means for retrieving links is operative to retrieve where the value satisfies a data type operation specified in the query In another aspect of the present invention a system is provided for querying semi-structured document indices, the system including means for appending a context delimiter followed to a value of a query, thereby forming a context-modified value, means for traversing, in a free-text index, one or more text nodes corresponding to the context-modified value until the traversed text nodes form the context-modified value, and means for retrieving any links associated with any of the text nodes corresponding to the context delimiter, thereby forming results of the query.

In another aspect of the present invention the means for retrieving is additionally operative to retrieving any links associated with any text nodes descending from the text node corresponding to the context delimiter, thereby forming results of the query.

In another aspect of the present invention a system is provided for querying semi-structured document indices, the system including means for traversing, in a context structure index, one or more context nodes corresponding to a context path of a query until a context node corresponding to a terminus of the context path is reached, means for retrieving a context identifier of the context node, means for traversing, in a free-text index, one or more text nodes corresponding to a value of the query, where the value is of a context-specific wildcard query construct, until the traversed text nodes form the value, and means for retrieving any links associated with any text nodes of the free-text index that descend from the terminus of the traversed value and that are at the desired context identifier, thereby forming results of the query.

In another aspect of the present invention a computer program is provided embodied on a computer-readable medium, the computer program including a first code segment operative to arrange at least one structure entity of a semi-structured document into at least one node of a context structure tree, a second code segment operative to associate a unique context identifier with any of the structure entities, a third code segment operative to create a context-modified value for any value of any of the structure entities by appending a context delimiter and the context identifier to the value, and a fourth code segment operative to insert the context-modified value into a free-text tree.

It is appreciated through the specification and claims that the terms “file” and “document” are used interchangeably, and refer to any collection of data, text, or other types of information.

### BRIEF DESCRIPTION OF THE DRAWINGS

The present invention will be understood and appreciated more fully from the following detailed description taken in conjunction with the appended drawings in which:

FIG. 1 is a simplified flow illustration of a method of indexing semi-structured documents, operative in accordance with a preferred embodiment of the present invention;

FIG. 2A is a simplified illustration of a context structure tree, constructed and operative in accordance with a preferred embodiment of the present invention;

FIG. 2B is a simplified illustration of a free-text tree, constructed and operative in accordance with a preferred embodiment of the present invention;

FIG. 3A is a simplified illustration of a context structure tree, constructed and operative in accordance with a preferred embodiment of the present invention;

FIG. 3B is a simplified illustration of a free-text tree, constructed and operative in accordance with a preferred embodiment of the present invention;

FIGS. 4A, 4B, and 4C, which are simplified flow illustrations of a method of querying semi-structured document indices, operative in accordance with a preferred embodiment of the present invention; and

FIG. 5 is a simplified flow illustration of a method of querying semi-structured document indices using data type operators, operative in accordance with a preferred embodiment of the present invention.

### DETAILED DESCRIPTION OF PREFERRED EMBODIMENTS

Preferred embodiments of the present invention are now described with respect to semi-structured documents that employ the Extensible Markup Language (XML), such as those that reside on the portion of the Internet known as the World Wide Web (hereinafter “the Web”). It should be noted, however, that the present invention is not limited to use with XML-based documents, and may be utilized for any semi-structured document, or any document that can be parsed to produce context-value pairs.

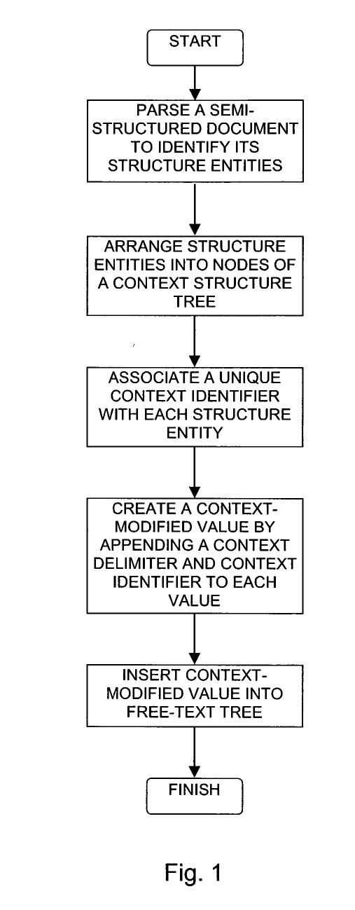

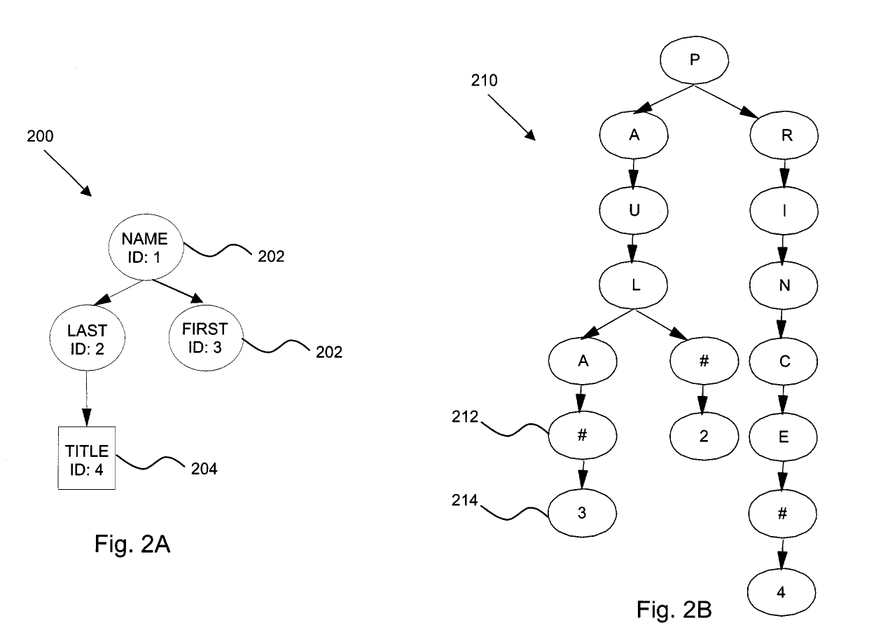

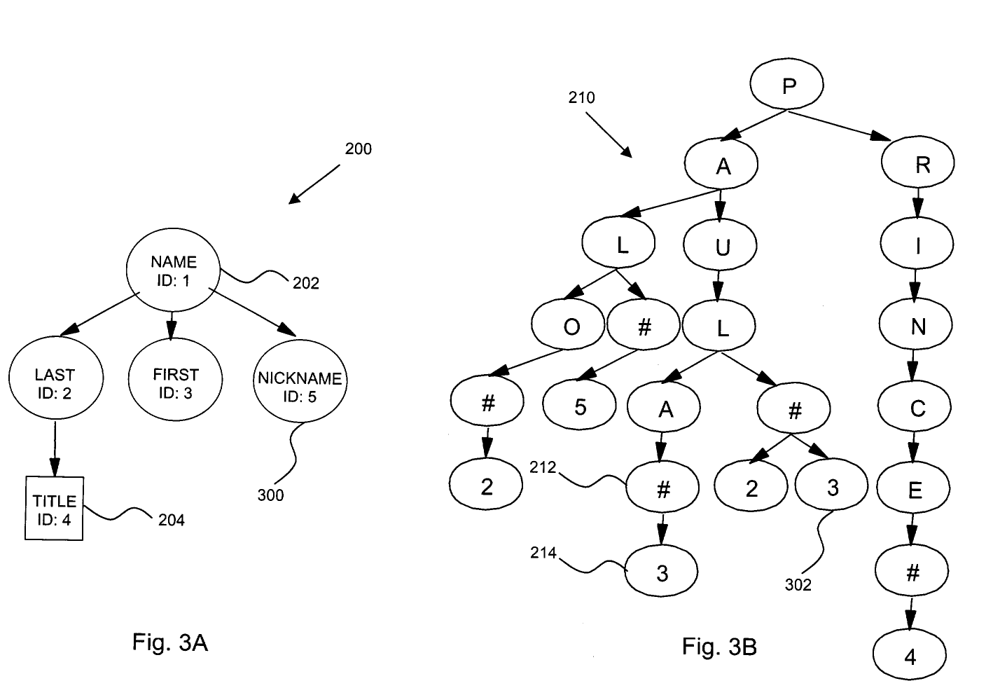

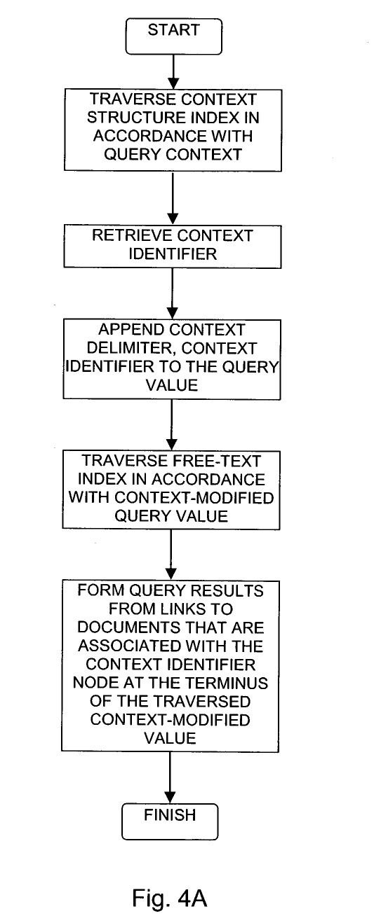

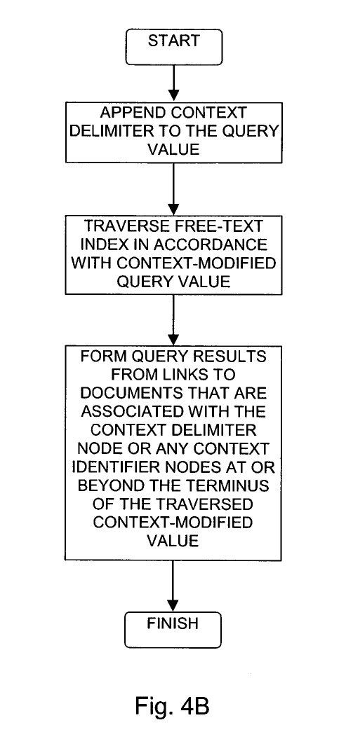

Reference is now made to FIG. 1, which is a simplified flow illustration of a method of indexing semi-structured documents, operative in accordance with a preferred embodiment of the present invention, and additionally to FIGS. 2A and 3A, which are simplified illustration of a context structure tree, and FIGS. 2B and 3B, which are simplified illustration of a free-text tree, constructed and operative in accordance with a preferred embodiment of the present invention. It is appreciated that while aspects of the present invention are expressed pictorially as trees, these aspects are intended to be implemented as software indices using conventional techniques, and the terms “tree” and “index” and variations thereof may be used interchangeably.

In the method of FIG. 1, a semi-structured document is parsed to identify all data elements and attributes, hereinafter referred to as “structure entities,” which are then arranged into nodes of a context structure tree. For example, where the document is an XML document, it may be parsed using an XML parser, and a corresponding Data Object Model (DOM) tree representing the structure of the document may then be obtained. Each structure entity represents a node of the context structure tree, with branches representing nested structure entities. A unique context identifier is then associated with each structure entity node.

FIG. 2A shows a context structure tree 200 constructed from the elements 202 (i.e., “name,” “last,” and “first”) and attributes 204 (i.e., “title”) of the following sample XML document, first.xml:

<name>

<last title=”prince”> paul </last>
<first> paula </first>

</name>

A free-text tree is also prepared from the document's structure entity values (i.e., “prince,” “paul,” and “paula”), preferably where each character represents a node. As each value is added to the free-text tree, a predefined context delimiter, such as “#”, is appended to the value, followed by the context identifier of the value's corresponding structure entity. Where two or more values share a common prefix (e.g., “paul” and “paula” both share the prefix “paul”) the prefix may be added once for both values, with appropriate branching added for each unique suffix.

FIG. 2B shows a free-text tree 210 constructed from the values “prince,” “paul,” and “paula,” including context delimiter nodes 212 and context identifier nodes 214. Links to first.xml (not shown), such as part of a posting list, may be associated with any of the nodes of index 210 in accordance with conventional techniques, preferably with context delimiter nodes 212 and/or context identifier nodes 214.

Additional semi-structured documents are added to context structure tree 200 and free-text tree 210 as follows. Where a structure entity in a document to be added does not exist in context structure tree 200, it is added to context structure tree 200 and assigned a unique context identifier as described above. Where the structure entity already exists in context structure tree 200, it need not be added to context structure tree 200. Similarly, if the value of the structure entity, or a suffix thereof, together with the context delimiter and its context identifier does not exit in free-text tree 210, it is added to free-text tree 210 as described above. Otherwise, the value or suffix need not be added. As before, links to the document may be associated with any of the nodes of index 210, and preferably with context identifier nodes 214.

FIG. 3A shows context structure tree 200 of FIG. 2A after it has been modified to include the structure entities of the following additional sample XML document, second.xml:

<name>

<first> paul </first>
<last> palo </last>
<nickname> pal </nickname>

</name>

It may be seen in FIG. 3A that only the element “nickname” (300) and its unique context identifier have been added, as the elements “name,” “first,” and “last” already exist.

FIG. 3B shows free-text tree 210 of FIG. 2A after it has been modified to include the values “palo” and “pal.” An identifier node 302 has also been added to indicate that “paul” is associated with the “first” name element of second.xml whose identifier is 3, in addition to “Paul” being associated with the “last” name element of first.xml whose identifier is 2.

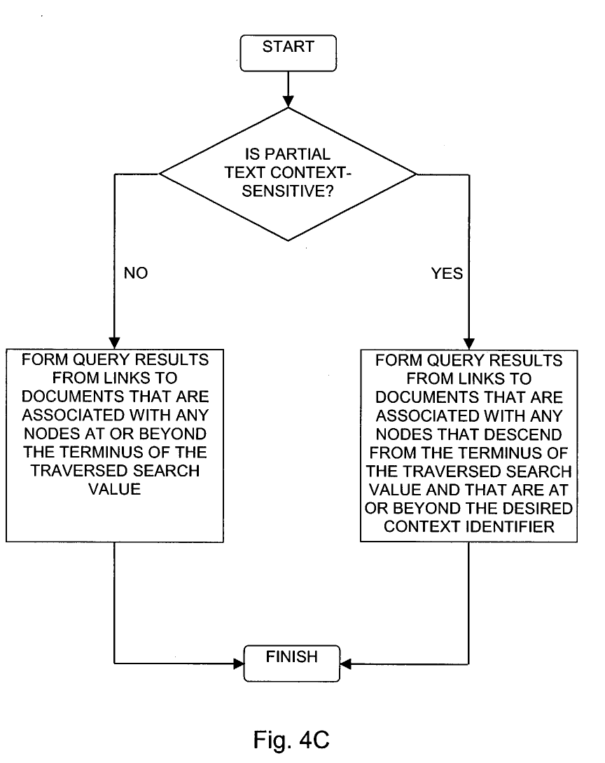

Reference is now made to FIGS. 4A, 4B, and 4C, which are simplified flow illustrations of a method of querying semi-structured document indices, operative in accordance with a preferred embodiment of the present invention. In the method of FIGS. 4A and 4B a query is parsed to determine whether the query is a context-sensitive query, a free text query, or a composite query with both context-sensitive and free text components. For example, the query construct “/context/context/ . . . /value” may be used to express a context-sensitive query in the form of a context path within a context structure tree, where each contextual structure entity is separated by a delimiter, such as “/”, and the last part of the query construct is a value to be searched in a related free text tree. Thus in FIG. 4A, continuing with the example of FIGS. 3A and 3B above, a query requesting documents in which “paul” is a first name may be expressed as “/name/first/paul”, indicating a context “name” comprising a nested context “first” whose value is “paul.” Once the query has been identified as a context-sensitive query the context structure index is searched by traversing the context path until the node corresponding to the terminus of the context path is reached. Thus, in the current example, the context structure index is traversed from the node “name” to the node “first”, whose context identifier, “3” in the current example, is then retrieved. The context delimiter is then appended to the value to be searched, followed by the retrieved context identifier, to form a context-modified value, or “paul#3” in the current example. The free-text index is then searched by finding a node having the value “p” and then traversing to a connected node having the value “a” and so on until the traversed nodes form the context-modified value. Any links to documents that are associated with the context identifier node at the terminus of the traversed context-modified value may then be retrieved to form the results of the query.

Similarly, the query construct “/value” or “value” may be used to express a free-text query indicating a value to be searched in a related free text tree, not in any particular context. Thus in FIG. 4B, continuing with the example of FIGS. 3A and 3B above, a query requesting documents in which “paul” appears in any context may be carried out by appending the context delimiter to the value to be searched to form a context-modified value, or “paul#” in the current example. The free-text index is then searched as before until the traversed nodes form the context-modified value. Any links to documents that are associated with the context delimiter node or any context identifier nodes at or descending from the terminus of the traversed context-modified value may then form the results of the query.

Partial text queries may be accommodated using a context-independent wildcard query construct, such as /paul* or paul*, or a context-specific wildcard query construct, such as /name/first/paul*. Thus in FIG. 4C, where the partial text is independent of a particular context, any links to documents that are associated with any nodes at or descending from the terminus of the traversed search value may then form the results of the query. Where the partial text is context-specific, any links to documents that are associated with any nodes that descend from the terminus of the traversed search value and that are at the desired context identifier may then form the results of the query.

Each free-text and context-sensitive portion of a composite query may be processed separately as described above, with their results being merged using conventional techniques according to the logical operators being applied.

It is appreciated that each word in a multi-word value, such as in <last title=“prince of wales”>, maybe separately processed as individual words in accordance with the method of FIG. 1 above. A query involving a multi-word value may then be handled as multiple queries, one for each word in the multi-word value, with the query results including documents that include, for example, at least one of the words in the desired context, ranked by relevance to the query.

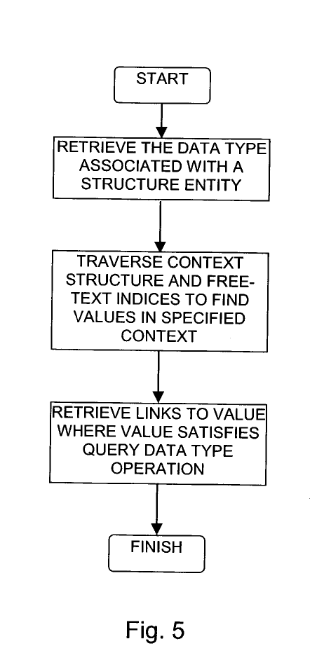

Reference is now made to FIG. 5, which is a simplified flow illustration of a method of querying semi-structured document indices using data type operators, operative in accordance with a preferred embodiment of the present invention. In the method of FIG. 5 the data type of a structure entity is stored in association with its corresponding node. A query construct may thus include an expression to be evaluated in accordance with the data type of a structure entity. Thus, given the following indexed semi-structured document:

<order>

<partNum> 10006572 </partNum>
<partDescription> widget </partDescription>
<quantity> 74 </quantity>

</order>

the query “/order/partDescription/widget/and/order/quantity/>/52” representing orders of more than 52 widgets may be evaluated by searching the context structure and free-text indices as described above. In one preferred method for facilitating such queries, a table is preferably maintained for each context node in the context structure tree including pointers to all words that appear in the given context. All words (e.g., <quantity> values in the example) in the context being queried (e.g., <order>/<quantity> in the example) may thus be retrieved and tested with the indicated data type operator (e.g., >52 in the example). Words that pass the test are then searched in the free-text index as described above.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for indexing a semi-structured document, the method comprising:
arranging at least one structure entity of a semi-structured document into at least one node of a context structure tree;
associating a unique context identifier with any of said structure entities;
for any value of any of said structure entities, creating a context-modified value by appending a context delimiter and said context identifier to said value; and
inserting said context-modified value into a free-text tree.

2. A method according to claim 1 and further comprising parsing said semi-structured document to identify any of said structure entities therein.

3. A method according to claim 1 wherein said associating step comprises associating a unique context identifier with any of said structure entities.

4. A method according to claim 1 wherein said inserting step comprises inserting either of said context delimiter and said context identifier as nodes in said free-text tree.

5. A method according to claim 4 and further comprising associating at least one link to said semi-structured document with any of said nodes in said free-text tree.

6. A method according to claim 1 and further comprising storing a data type of at least one of said structure entities in association with its corresponding node.

7. A method for querying semi-structured document indices, the method comprising:
traversing, in a context structure index, one or more context nodes corresponding to a context path of a query until a context node corresponding to a terminus of said context path is reached;
retrieving a context identifier of said context node;
appending a context delimiter followed by said context identifier to a value of said query, thereby forming a context-modified value;
traversing, in a free-text index, one or more text nodes corresponding to said context-modified value until said traversed text nodes form said context-modified value; and
retrieving any links associated with any of said text nodes corresponding to either of said context delimiter and said context identifier node, thereby forming results of said query.

8. A method according to claim 7 and further comprising retrieving a data type of said context node, and wherein said retrieving links step comprises retrieving where said value satisfies a data type operation specified in said query.

9. A method for querying semi-structured document indices, the method comprising:
appending a context delimiter followed to a value of a query, thereby forming a context-modified value;
traversing, in a free-text index, one or more text nodes corresponding to said context-modified value until said traversed text nodes form said context-modified value; and
retrieving any links associated with any of said text nodes corresponding to said context delimiter, thereby forming results of said query.

10. A method according to claim 9 wherein said retrieving step additionally comprises retrieving any links associated with any text nodes descending from said text node corresponding to said context delimiter, thereby forming results of said query.

11. A method for querying semi-structured document indices, the method comprising:
traversing, in a context structure index, one or more context nodes corresponding to a context path of a query until a context node corresponding to a terminus of said context path is reached;
retrieving a context identifier of said context node;
traversing, in a free-text index, one or more text nodes corresponding to a value of said query, wherein said value is of a context-specific wildcard query construct, until said traversed text nodes form said value; and
retrieving any links associated with any text nodes of said free-text index that descend from the terminus of said traversed value and that are at the desired context identifier, thereby forming results of said query.

12. Apparatus for indexing a semi-structured document, comprising:
a context structure tree comprising at least one node corresponding to at least one structure entity of a semi-structured document and a unique context identifier associated with said structure entity;
a context-modified value comprising a value of said structure entity, a context delimiter, and said context identifier; and
a free-text tree into which said context-modified value is inserted.

13. A system for indexing a semi-structured document, the system comprising:
means for arranging at least one structure entity of a semi-structured document into at least one node of a context structure tree;
means for associating a unique context identifier with any of said structure entities;
means for creating a context-modified value for any value of any of said structure entities by appending a context delimiter and said context identifier to said value; and
means for inserting said context-modified value into a free-text tree.

14. A system according to claim 13 and further comprising means for parsing said semi-structured document to identify any of said structure entities therein.

15. A system according to claim 13 wherein said means for associating is operative to associate a unique context identifier with any of said structure entities.

16. A system according to claim 13 wherein said means for inserting is operative to insert either of said context delimiter and said context identifier as nodes in said free-text tree.

17. A system according to claim 16 and further comprising means for associating at least one link to said semi-structured document with any of said nodes in said free-text tree.

18. A system according to claim 13 and further comprising means for storing a data type of at least one of said structure entities in association with its corresponding node.

19. A system for querying semi-structured document indices, the system comprising:
means for traversing, in a context structure index, one or more context nodes corresponding to a context path of a query until a context node corresponding to a terminus of said context path is reached;
means for retrieving a context identifier of said context node;
means for appending a context delimiter followed by said context identifier to a value of said query, thereby forming a context-modified value;
means for traversing, in a free-text index, one or more text nodes corresponding to said context-modified value until said traversed text nodes form said context-modified value; and
means for retrieving any links associated with any of said text nodes corresponding to either of said context delimiter and said context identifier node, thereby forming results of said query.

20. A system according to claim 19 and further comprising means for retrieving a data type of said context node, and wherein said means for retrieving links is operative to retrieve where said value satisfies a data type operation specified in said query.

21. A system for querying semi-structured document indices, the system comprising:
means for appending a context delimiter followed to a value of a query, thereby forming a context-modified value;
means for traversing, in a free-text index, one or more text nodes corresponding to said context-modified value until said traversed text nodes form said context-modified value; and
means for retrieving any links associated with any of said text nodes corresponding to said context delimiter, thereby forming results of said query.

22. A system according to claim 21 wherein said means for retrieving is additionally operative to retrieving any links associated with any text nodes descending from said text node corresponding to said context delimiter, thereby forming results of said query.

23. A system for querying semi-structured document indices, the system comprising:
means for traversing, in a context structure index, one or more context nodes corresponding to a context path of a query until a context node corresponding to a terminus of said context path is reached;
means for retrieving a context identifier of said context node;
means for traversing, in a free-text index, one or more text nodes corresponding to a value of said query, wherein said value is of a context-specific wildcard query construct, until said traversed text nodes form said value; and
means for retrieving any links associated with any text nodes of said free-text index that descend from the terminus of said traversed value and that are at the desired context identifier, thereby forming results of said query.

24. A computer program embodied on a computer-readable medium, the computer program comprising:
a first code segment operative to arrange at least one structure entity of a semi-structured document into at least one node of a context structure tree;
a second code segment operative to associate a unique context identifier with any of said structure entities;
a third code segment operative to create a context-modified value for any value of any of said structure entities by appending a context delimiter and said context identifier to said value; and
a fourth code segment operative to insert said context-modified value into a free-text tree.
